(19) United States
(12) Patent Application Publication
(10) Pub. No.: US 2008/0156628 A1
(43) Pub. Date: Jul. 3, 2008

(54) Switch apparatus

(75) Inventor: Takeshi Fujimoto, Aichi (JP)

Correspondence Address: MORGAN LEWIS & BOCKIUS LLP, 1111 PENNSYLVANIA AVENUE NW, WASHINGTON, DC, 20004, US

(73) Assignee: Kabushiki Kaisha Tokai Rika Denki Seisakusho

(21) Appl. No.: 12/003,160

(22) Filed: Dec. 20, 2007

(30) Foreign Application Priority Data
Dec. 27, 2006 (JP) P2006-352302

(51) Int. Cl. H01H 3/42

(52) U.S. Cl. 200/524

(57) ABSTRACT

A door mirror retraction switch apparatus is configured to include a switch case, an insulator in which an actuator is disposed movably which is provided in an interior of the switch case in such a manner as to be surrounded by the switch case, and a lock mechanism, and a guide portion of the lock mechanism is formed in the insulator in such a manner as to have an opening which is made to open to an external surface of the insulator at one end thereof and to extend inwards of the insulator in a groove-like fashion from the opening, a lock member is movably inserted into the guide portion, and the opening of the guide portion is made to be closed by the switch case.

### BACKGROUND OF THE INVENTION

The present invention relates to a switch apparatus including a lock mechanism for locking an actuator in a switch actuating position by a lock member based on push-operation of a controller.

Conventionally, as switches of this type, there is known, for example, an automotive outside rearview mirror retraction switch apparatus (for example, JP-A-2002-100254). In this switch apparatus, when a controller is push-operated, an actuator moves to actuate a switch portion for retracting an outside rearview mirror to switch it on. In addition, as this occurs, a lock mechanism is actuated, so as to lock the actuator in the switch actuating position. When the controller is push-operated subsequently, the actuator is released from the lock in the switch actuating position, so that the actuator is allowed to return to its original position. An example of a lock mechanism for locking the actuator in the way described above will be briefly described. The configuration of the lock mechanism is shown in FIGS. 6 to 8.

Namely, FIGS. 6 to 8 show a switch apparatus 1 for operating an outside rearview mirror of a vehicle. An outside rearview mirror retracting controller 2 is provided in a switch case 1a of the switch apparatus 1, and when the user push-operates this controller 2, an actuator, not shown, is caused to move, so as to actuate a switch portion. In association with this operation, a lock mechanism (a lock member 3 which is part of the lock mechanism and a guide portion 4 being shown) locks the actuator in a switch actuating position thereof (a switch actuating state being locked). In addition, when the user push-operates the controller 2 subsequently or again, the actuator is released from the lock to be allowed to return to its original position.

Here, the lock member 3 is inserted movably in the guide portion 4 which is formed in the switch case 1a. An opening 4a of the guide portion 4 is configured to be closed by a seal 5. Note that this switch apparatus 1 is such as to be incorporated appropriately in a panel accommodating portion of a vehicle.

In the configuration shown in FIGS. 6 to 8, since the guide portion 4 and the opening 4a are formed in the switch case 4a, there is a fear that dust or the like is allowed to enter the interior of the switch apparatus 1 from the opening 4a, and in order to prevent this drawback, the opening 4a needs to be closed by the seal 5.

### SUMMARY OF THE INVENTION

The invention has been made in view of the situations above, and an object thereof is to provide a switch system which can eliminate the opening in the external surface of the switch system formed for insertion of the lock member, so as to eliminate the fear of intrusion of dust and which can do away with a separate member such as the seal.

According to a first aspect of the invention, there is provided a switch apparatus including a switch case in which a controller is disposed in such a manner as to be operated, an insulator in which an actuator is disposed movably which is provided in an interior of the switch case in such a manner as to be surrounded by the switch case, and a lock mechanism, the actuator being locked in a switch actuating position by the lock mechanism based on push-operation of the controller, the operator being allowed to return from the switch actuating position to an original position thereof by releasing the actuator from the lock in the switch actuating position based on subsequent push-operation of the controller, wherein the lock mechanism is configured to have a guide portion which is formed in the insulator in such a manner as to have an opening which is made to open to an external surface of the insulator at one end thereof and to extend inwards of the insulator in a groove-like fashion from the opening, a lock member movably inserted into the guide portion, and an engagement portion which is formed on the actuator and is adapted to cause the lock member to perform a locking operation and a lock releasing operation based on movements of the actuator, and wherein the opening of the guide portion is made to be closed by the switch case.

In the first aspect of the invention, since the configuration is adopted in which the guide portion of the lock mechanism is formed in the insulator, the lock member is inserted into the guide portion so as to be disposed in place therein, and the opening of the guide portion is closed by the switch case, the opening formed in the external surface of the guide portion for insertion of the lock member can be eliminated, so as to eliminate the fear of intrusion of dust, and the necessity is obviated of using a separate member such as the seal.

According to the invention, the opening can be eliminated which is formed in the external surface of the switch apparatus for insertion of the lock member.

### BRIEF DESCRIPTION OF THE DRAWINGS

FIG. 1 is an exploded perspective view of a mirror retraction switch apparatus showing an embodiment of the invention.

FIG. 2 is a front view of the same.

FIG. 3 is a side view of the same.

FIG. 4 is a sectional view taken along the line Q-Q in FIG. 2.

FIG. 5 is a sectional view taken along the line R-R in FIG. 2.

FIG. 6 is a drawing corresponding to FIG. 2, which illustrates a conventional example.

FIG. 7 is a drawing corresponding to FIG. 3.

FIG. 8 is an exploded perspective view of the conventional example.

### DETAILED DESCRIPTION OF PREFERRED EMBODIMENTS

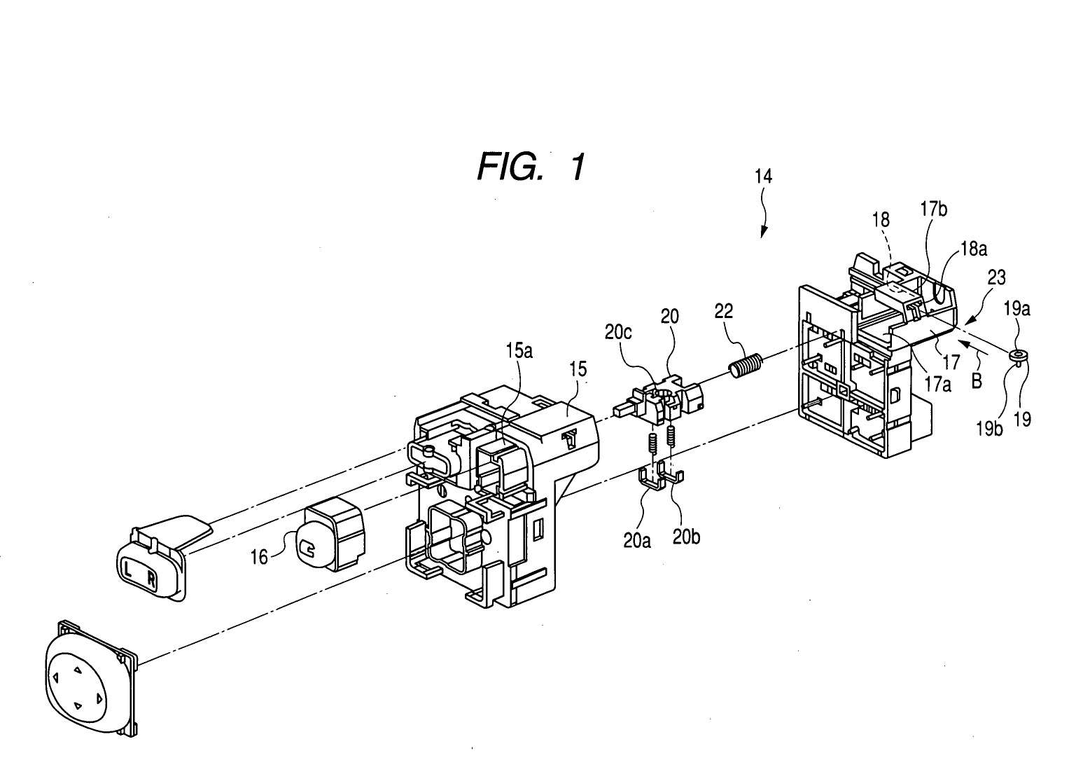

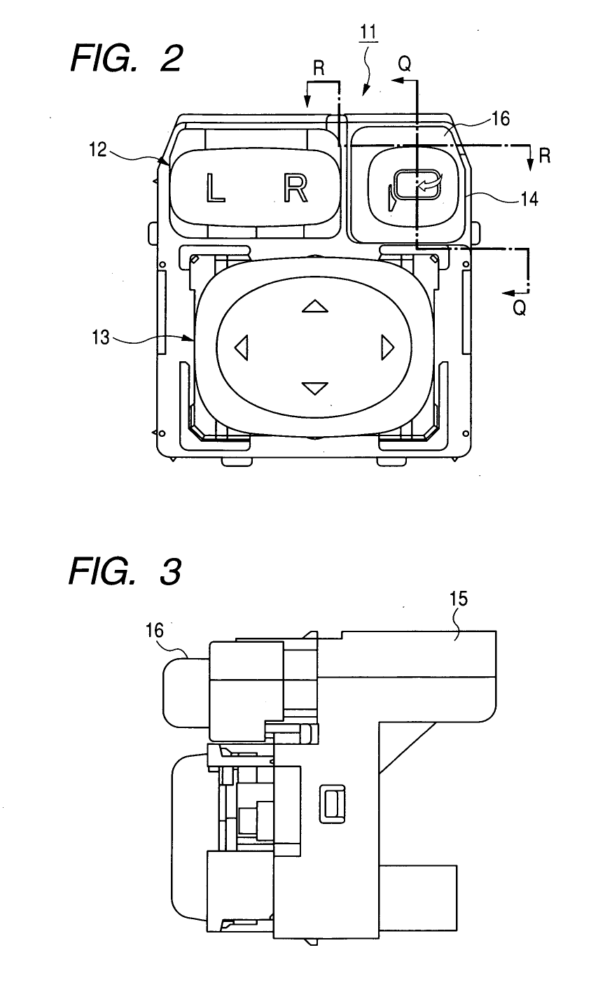

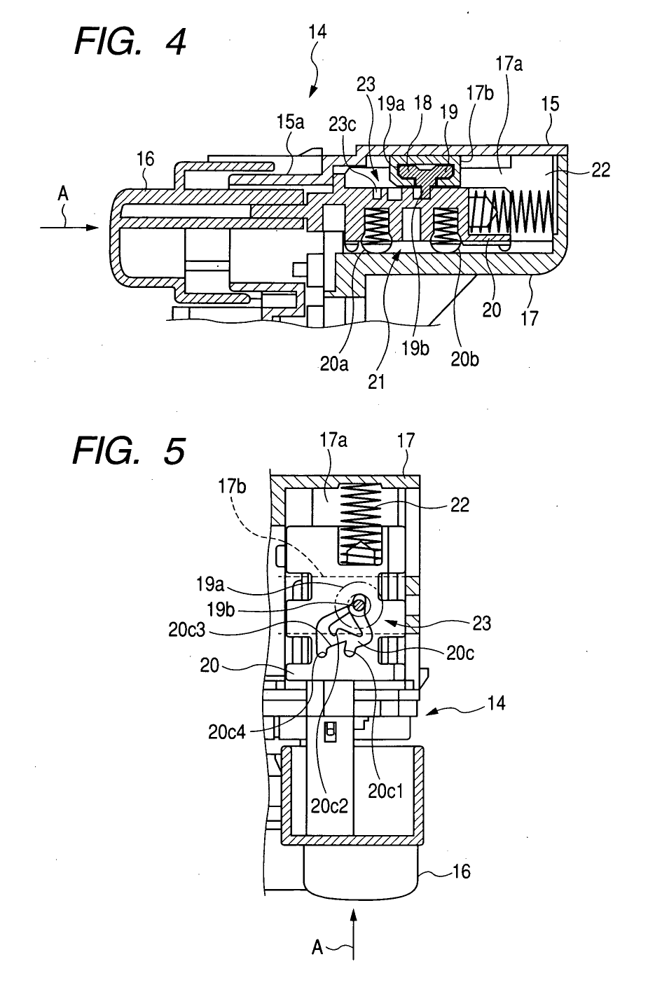

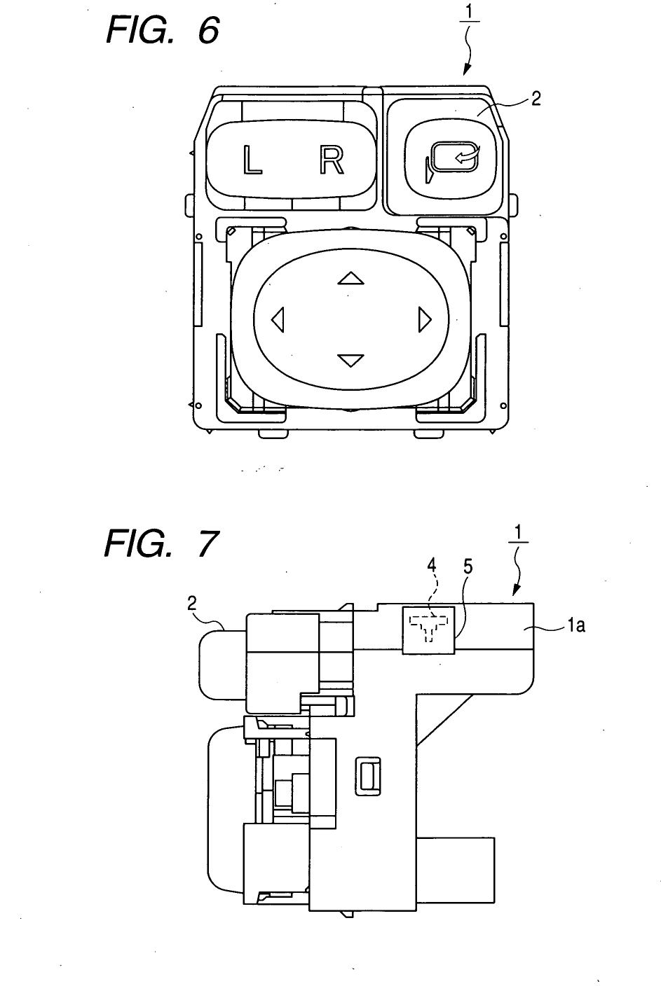

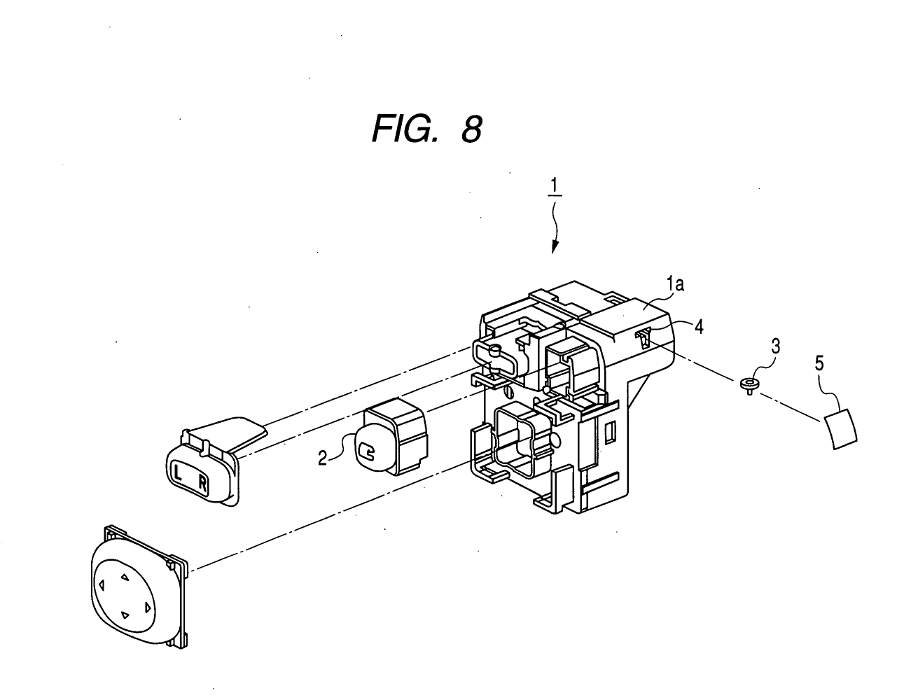

Hereinafter, referring to FIGS. 1 to 5, an embodiment of the invention will be described. An outside rearview mirror retraction switch system 11 is configured to include a mirror switching unit 12, a mirror angle adjusting switch 13 and a mirror retraction switch apparatus 14 which corresponds to the switch apparatus of the invention. Hereinafter, the mirror retraction switch apparatus 14 of the outside rearview mirror retraction switch system 11 will be described.

A holding tubular portion 15a is formed on a front side of a switch case 15 of the mirror retraction switch apparatus 14. A controller 16, which is adapted to be push-operated in a direction indicated by an arrow A by the user, is movably disposed on the holding tubular portion 15a. A rear side of the switch case 15 is made open, and an insulator 17 is inserted into an interior of the switch case 15 from the rear side so as to be provided in place therein.

An actuator accommodating portion 17a is formed in this insulator 17, and stationary contacts, not shown, are provided on a bottom portion of the actuator accommodating portion 17a. Furthermore, a lock guide 17b is formed in a bridge like fashion in an upper portion of the actuator accommodating portion 17a, and a guide portion 18 is formed on the lock guide 17b which constitutes part of a lock mechanism 23. This guide portion 18 is formed in such a manner as to have an opening 18a which is made to open in an end face of the lock guide 17b at one end thereof and to extend in a direction indicated by an arrow B (inwards of the insulator) from the opening 18a in the form of a T-shaped groove.

A lock member 19 is movably inserted and disposed in the guide portion 18. This lock member 19 is made up of a substantially disc-shaped flange portion 19a and an engaged stem portion 19b which suspends downwards from substantially a central portion on a lower portion of the flange portion 19a. This flange portion 19a is disposed in a horizontal groove portion of the guide portion 18, and the engaged stem portion 19b projects downwards through a vertical groove portion.

In addition, an actuator 20 is movably provided in the actuator accommodating portion 17a. Movable contacts 20a, 20b are provided on a lower surface of the actuator 20 and make up a switch portion 21 together with the stationary contacts, which is not shown. In addition, an engagement groove 20c which is made up, for example, of a so-called heart cam groove is formed on an upper surface of the actuator 20, and a lower end portion of the engaged stem portion 19b is fitted in this engagement groove 20.

The actuator 20 is normally movably biased in an opposite direction to the direction indicated by the arrow A by a spring 22.

The lock mechanism 23 is made up of the guide portion 18, the lock member 19 and the engagement groove 20c. Here, the opening 18a of the guide portion 18 is closed by the switch case 15.

In the configuration that has been described heretofore, when the user push-operates the controller 16 in the direction indicated by the arrow A, the actuator 20 moves in the direction indicated by the arrow A, and the movable contacts 20a, 20b are brought into contact with the stationary contacts for energization, that is, the switch portion 21 is actuated to switch on the unit. As this occurs, by the movement of the engagement groove 20c in association with the movement of the actuator 20, the engagement groove 20c moves the lock member 19 in the direction indicated by the arrow B or in an opposite direction thereto so as to cause the lock member 19 to reach a first locking portion 20c1 of the engagement groove 20c.

Here, when the user releases the push-operation force applied to the controller 16, although the actuator 20 moves in an opposite direction to the direction indicated by the arrow A, a second locking portion 20c2 comes to be faced with the lock member 19 so as to restrict the movement of the actuator 20 in the opposite direction to the direction indicated by the arrow A, whereby the switching operation of the switch portion 21 is locked. In addition, the mirror (the outside rearview mirror on the door) of the vehicle rotates in such a manner as to approach the door side by this switching operation, in other words, the mirror is retracted.

In addition, when the user push-operates the controller 16 again or subsequently, an inclined portion 20c3 of the engagement groove 20c of the actuator 20 comes to be faced with the lock member 19 to thereby move the lock member 19 in the direction indicated by the arrow B, whereby the lock member 19 moves into a third locking portion 20c4, and when the user releases the push-operation force applied to the controller 16, the actuator 20 moves in the direction opposite to the direction indicated by the arrow A, and the switching operation is switched off, the actuator 20 being allowed to return to its original position. The door mirror returns to the position where it projects outwards from the door based on the switching-off operation.

According to the embodiment that is configured as has been described heretofore, since the configuration is adopted in which the guide portion 18 of the lock mechanism 23 is formed on the insulator 17, the lock member 19 is inserted and disposed in this guide portion 18, and the opening 18a of the guide portion is closed by the switch case 15, the lock member insertion opening in the mirror retraction switch apparatus 14 of the outside rearview mirror retraction switch system 11 or in the external surface of the external surface in the outside rearview mirror retraction system 11 can be eliminated, thereby making it possible not only to eliminate the fear of intrusion of dust but also to do away with a separate member such as a seal.

Note that the invention is limited to the embodiment but can be carried out based on the following changes and modifications. For example, while in the embodiment, the invention is described as being applied to the mirror retraction switch apparatus, the invention can be applied to a switch apparatus which includes a lock mechanism. In addition, the configuration of the lock member and the configuration of the engagement portion may be modified as required.

What is claimed is:

1. A switch apparatus comprising:
a switch case;
a controller disposed in the switch case so that the controller can be operated;
an insulator provided in an interior of the switch case and surrounded by the switch case;
an actuator movably disposed in the insulator; and
a lock mechanism that locks the actuator in a switch actuating position based on push-operation of the controller, and allows the actuator to return from the switch actuating position to an original position based on subsequent push-operation of the controller,
wherein the lock mechanism includes:
a guide portion formed in the insulator, the guide portion including an opening opened to an external surface and extending inwards of the insulator in a groove-like fashion from the opening;
a lock member movably inserted into the guide portion; and
an engagement portion which is formed on the actuator and is adapted to cause the lock member to perform a locking operation and a lock releasing operation based on the movement of the actuator, and
wherein the opening of the guide portion is made to be closed by the switch case.

2. The switch apparatus according to claim 1, wherein
a stationary contact is provided on the insulator, and
a movable contact is provided on the actuator and is adapted to be connected to or disconnected from the stationary contact in association with movement of the actuator so as to make up a switch portion together with the stationary contact.
